(19) United States
(12) Patent Application Publication
(10) Pub. No.: US 2002/0071663 A1
(43) Pub. Date: Jun. 13, 2002

(54) Digital video recording system having multi-pass video processing

(76) Inventor: John Setel O'Donnel, Seattle, WA (US)

Correspondence Address: Equator Technology, Inc., Intellectual Property Counsel, 6850 Austin Center Blvd., Suite 220, Austin, TX, 78731, US

(21) Appl. No.: 09/732,409

(22) Filed: Dec. 7, 2000

(51) Int. Cl. H04N 7/26

(52) U.S. Cl. 386/109

(57) ABSTRACT

A system and method for enabling a consumer video appliance (CVA) to perform, during periods of low activity, high compression of stored, low-compressed video streams. In addition, the CVA may enhance, during periods of low activity, picture/audio quality of stored, compressed video streams.

### BACKGROUND OF THE INVENTION

1. Technical Field

The present invention relates generally to digital video recording systems, and, in particular, to digital video recording systems that, in part, compress digital video streams.

2. Background Art

In general, in the descriptions that follow, I will italicize the first occurrence of each special term of art which should be familiar to those skilled in the art of video recording and transmission systems. In addition, when I first introduce a term that I believe to be new or that I will use in a context that I believe to be new, I will bold the term and provide the definition that I intend to apply to that term. In addition, throughout this description, I will use the terms assert and negate when referring to the rendering of a signal, signal flag, status bit, or similar apparatus into its logically true or logically false state, respectively.

It is well known that the transmission of digitized streams of live-capture video/audio sequences requires high bandwidth media. Significant bandwidth reduction can be achieved by compressing the digital video stream using any of a number of known compression algorithms. The common goal of all such compression systems is to reduce the bandwidth required to transmit the video sequences such that they can be reproduced in real-time from the perspective of the viewer. To promote industry standardization, the Motion Picture Experts Group (“MPEG”) has promulgated several standard compression algorithms, each providing a known level of compression, computational complexity, and picture quality. The widely-accepted second-generation MPEG standard (“MPEG-2”) provides reasonable compression at a moderate computational complexity, whereas the newer, fourth-generation standard (“MPEG-4”) provides significantly greater compression but at substantially higher computational complexity; both providing quite acceptable reproduced picture and audio quality.

In present commercial, digital video distribution systems (e.g., terrestrial, cable, digital versatile disk (“DVD”), etc.), there is usually adequate time between the capture of the digital video stream and its distribution to accommodate the off-line application of the selected compression algorithm using any of the available video processing equipment. Typically, additional processing, such as noise-reduction, image enhancement, and, perhaps, picture resizing, is performed to improve overall picture quality. In those situations where real-time operation is required (e.g., televised sports events), the high-compression algorithms are typically applied using high-end video processing equipment. However, with currently available technology, physical size, power requirements, and high cost generally limits the use of the reduced data-rate, high-compression algorithms to either off-line or high-end systems.

Because of its moderate computational requirements, most existing digital video recorders (“DVR's”) and personal video recorders (“PVR's”) (which, for convenience, I shall refer to collectively as consumer video appliances or CVA's) compress, in real time, received digital video streams according to the MPEG-2 standard; recently announced CVA products will incorporate proprietary wavelet video compression technology. However, given the low cost and power limits demanded by the consumer marketplace, it is not feasible, either economically or technically, to employ, in real time, the computationally intensive, higher-compression algorithms. As a consequence, the less-highly compressed video streams will more quickly exhaust the available storage capacity of the hard-disk drive (“HDD”) in the CVA. Given the high demands made on the CVA's processor(s) in simply recording (including, live-capture, low compression and storing), it is unlikely that any significant computational capacity will be available to perform either high compression or picture/audio quality enhancement.

It is desirable that higher levels of compression be achieved in order to increase the effective capacity of the CVA's local storage. Further, CVA's should, to the extent possible, be enabled to enhance picture/audio quality.

### BRIEF SUMMARY OF THE INVENTION

In accordance with my invention, I provide a system and method for enabling a CVA to perform, during periods of low activity, high compression of stored, low-compressed video streams. In addition, in accordance with another embodiment of my invention, I enable a CVA to perform, in periods of low activity, enhancement of picture/audio quality of stored, compressed video streams.

### BRIEF DESCRIPTION OF THE SEVERAL VIEWS OF THE DRAWINGS

My invention may be more fully understood by a description of certain preferred embodiments in conjunction with the attached drawings in which:

FIG. 1 is a pictographic representation of a prior art CVA;

FIG. 2 is a flow diagram of a prior art record operation in the CVA of FIG. 1;

FIG. 3 is a flow diagram of a prior art playback operation in the CVA of FIG. 1;

FIG. 4 is a flow diagram of an off-line process according to the preferred embodiment of my invention

FIG. 5 is a flow diagram illustrating an enhance operation performed in accordance with the off-line process shown in FIG. 4; and

FIG. 6 is a flow diagram illustrating a high compression operation performed in accordance with the off-line process shown in FIG. 4.

In the drawings, similar elements will be similarly numbered whenever possible. However, this practice is simply for convenience of reference and to avoid unnecessary proliferation of numbers, and is not intended to imply or suggest that my invention requires identity in either function or structure in the several embodiments.

### DETAILED DESCRIPTION OF THE INVENTION

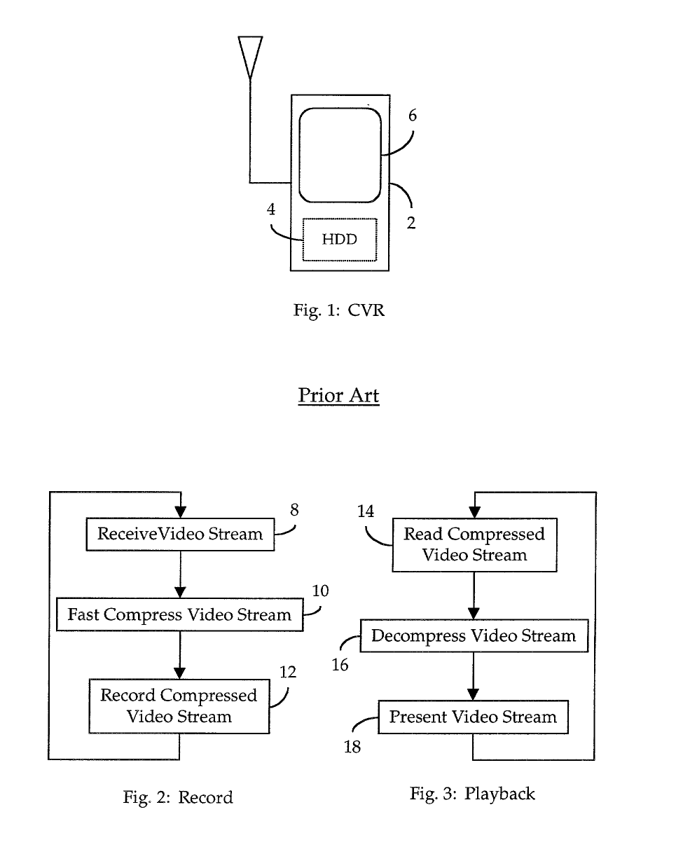

Shown by way of example in FIG. 1 is a CVA 2, which may consist of a stand-alone television set-top box, or as a component that is physically integrated into a multifunction television receiver. Typically, the CVA 2 includes: an RF (VHF/UHF/cable) tuner; baseband NTSC/PAL audio/video inputs; microprocessor controlled circuits which provide on-screen displays and a user interface to control the operation of the system; a remote control which enables the user to select programs or classes of programs for automatic recording; an EIDE HDD 4 which stores compressed, digitized audio and video streams; a compression processor which carries out real-time video compression; and video outputs for driving a display device 6. In a conventional record operation, as shown in FIG. 2, the CVA 2 receives an analog video stream in real time (step 8), compresses the video stream using a real-time compression algorithm (step 10), and records the compressed video stream on the HDD (step 12). By “real-time video compression”, I mean that the compression processor accepts analog audio and video inputs, and creates a stream of digital data of varying data rate which is then reduced in bandwidth from the pure digitized audio/video. As I have explained above, implementations found in the art today are based on either MPEG technology or wavelet video compression, and provide acceptable video quality using digital data rates ranging from 6 megabits (six million bits per second) to 2 megabits. During a conventional video playback operation, as shown in FIG. 3, the CVA 2 reads the compressed video stream from the HDD 4 (step 14), decompresses the compressed video stream back into baseband audio and video (step 16), and presents the reproduced analog video stream at its video outputs for display on the display device 6 (step 18). Recording and playback can occur either sequentially or simultaneously. For convenience of reference, I will use the term on-line to refer to the status of the CVA 2 when it is performing either a record or playback operation; in contrast, whenever the CVA 2 is not on-line, it is, by definition, off-line.

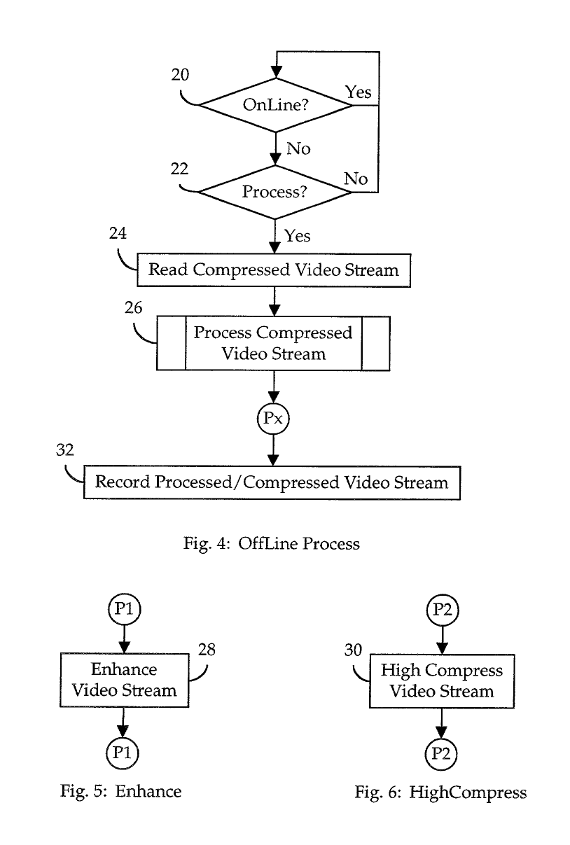

In accordance with my invention, whenever the CVA 2 performs a live-capture using in a convention record operation (FIG. 2), it will store a process record in a event database on the HDD 4. As shown in FIG. 4, when the CVA 2 is off-line (step 20), the CVA 2 will examine the database for a new process record. If it finds a new process record (step 22), the CVA 2 will read the respective compressed video stream (step 24), and then perform processing on the compressed video stream which was not economically or technically feasible to apply during live capture (step 26). For example, as shown in FIG. 5, the CVA 2 may enhance the video stream in any of a number of ways, including noise reduction, image enhancement, and picture resizing (step 28). Alternatively, as shown in FIG. 6, the CVA 2 may re-compress the video stream, using another high compression algorithm which may result in lower bitrate (step 30). Of course, if sufficient off-line time is available, the CVA 2 may perform both enhancement and recompression. When the desired off-line processing has been accomplished, the CVA 2 will record the processed, compressed video stream (step 32), and then update the respective process record to indicate which process(es) have been performed on the corresponding video stream so that the appropriate decompression algorithm can be applied during playback (see, step 16).

If desired, existing application specific integrated circuits may be employed to perform either the low compression process or the high compression process, or both. I prefer to use a high-performance, programmable media processor, such as one of the MAP Series of processors commercially available from Equator Technologies, Inc., 1300 White Oaks Road, Campbell, Calif. 95008, the assignee of the present application. Using such a programmable processor, my off-line process can easily implement any of a number of known video processing algorithms that either improve picture quality or lower bit-rate for previously stored material. Preferred enhancement algorithms include noise reduction, artifact elimination, and others used for non-real-time Internet streaming video authoring; preferred high compression algorithms include wavelet video processing, motion compensated DCT-based compression, and hybrid wavelet-motion compensated compression schemes.

When the CVA 2 again resumes on-line operation—either because of user input or automatic initiation—the CVA 2 makes a record of it's status and then suspends off-line processing. During the next off-line period, the CVA 2 may either resume the suspended process or initiate a new process. This latter course of action would be appropriate if, for example, during the interim on-line period, the user had discarded the particular video stream upon which the suspended operation was being performed. Thus, off-line processing does not interfere with either recording or playback, and does not raise the peak throughput needed in the system, but rather consumes system resources only when the CVA 2 would otherwise be idle.

Thus it is apparent that I have provided a system and method for enabling a CVA to perform, during periods of low activity, high compression of stored, low-compressed video streams. In addition, in accordance with another embodiment of my invention, I have enabled a CVA to enhance, during periods of low activity, picture/audio quality of stored video streams Those skilled in the art will recognize that modifications and variations can be made without departing from the spirit of my invention. Therefore, I intend that my invention encompass all such variations and modifications as fall within the scope of the appended claims.

What I claim is:

1. A video processing method comprising the steps of:
in a first mode of operation:
receiving a digitized video stream;
compressing said video stream using a selected first compression algorithm;
recording the compressed video stream;
creating a record indicating that said recorded, compressed video stream was compressed using said first compression algorithm; and
storing said record; and
in a second mode of operation, different from said first mode:
retrieving said stored record; and
if the retrieved record indicates that said recorded, compressed video stream was compressed using said first compression algorithm:
reading the recorded, compressed video stream;
processing said recorded, compressed video stream using a selected video processing algorithm;
recording the processed, compressed video stream;
modifying said record to indicate that said recorded, recompressed video stream was processed using said selected video processing algorithm; and
storing said modified record.

2. The method of claim 1 wherein said first mode of operation comprises on-line operation in real time.

3. The method of claim 2 wherein said second mode of operation comprises off-line operation in non-real time.

4. The method of claim 1 wherein:
said step of processing said recorded, compressed video stream is further characterized as:
re-compressing said recorded, compressed video stream using a selected second compression algorithm;
said step of recording the processed, compressed video stream is further characterized as:
recording the re-compressed video stream; and
said step of modifying said record is further characterized as:
modifying said record to indicate that said recorded, re-compressed video stream was re-compressed using said second compression algorithm.

5. The method of claim 1 wherein:
said step of processing said recorded, compressed video stream is further characterized as:
enhancing said recorded, compressed video stream using a selected enhancement algorithm;
said step of recording the processed, compressed video stream is further characterized as:
recording the enhanced, compressed video stream; and
said step of modifying said record is further characterized as:
modifying said record to indicate that said recorded, compressed video stream was enhanced using said selected enhancement algorithm.

6. The method of claim 1 wherein:
said step of processing said recorded, compressed video stream is further characterized as:
processing said recorded, compressed video stream using a selected enhancement algorithm and a selected second compression algorithm;
said step of recording the processed, compressed video stream is further characterized as:
recording the enhanced, re-compressed video stream; and
said step of modifying said record is further characterized as:
modifying said record to indicate that said recorded, enhanced, recompressed video stream was processed using said selected enhancement algorithm and said selected second compression algorithm.

7. A video processing method comprising the steps of:
in a first mode of operation:
receiving a digitized video stream;
compressing said video stream using a selected compression algorithm;
recording the compressed video stream;
creating a record indicating that said recorded, compressed video stream was compressed using said selected compression algorithm; and
storing said record; and
in a second mode of operation, different from said first mode:
retrieving said stored record; and
if the retrieved record indicates that said recorded, compressed video stream was compressed using said first compression algorithm:
reading the recorded, compressed video stream;
re-compressing said recorded, compressed video stream using a selected second compression algorithm;
recording the re-compressed video stream;
modifying said record to indicate that said recorded, recompressed video stream was re-compressed using said second compression algorithm; and
storing said modified record.

8. The method of claim 7 wherein said first mode of operation comprises on-line operation in real time.

9. The method of claim 8 wherein said second mode of operation comprises off-line operation in non-real time.

10. A video processing method comprising the steps of:
in a first mode of operation:
receiving a digitized video stream;
compressing said video stream using a selected compression algorithm;
recording the compressed video stream;
creating a record indicating that said recorded, compressed video stream was compressed using said selected compression algorithm; and
storing said record; and
in a second mode of operation, different from said first mode:
retrieving said stored record; and
if the retrieved record indicates that said recorded, compressed video stream was compressed using said first compression algorithm:
reading the recorded, compressed video stream;
enhancing said recorded, compressed video stream using a selected enhancement algorithm;
recording the enhanced, compressed video stream;
modifying said record to indicate that said recorded, compressed video stream was enhanced using said selected enhancement algorithm; and
storing said modified record.

11. The method of claim 10 wherein said first mode of operation comprises on-line operation in real time.

12. The method of claim 11 wherein said second mode of operation comprises off-line operation in non-real time.

13. A video processing method comprising the steps of:
in a first mode of operation:
receiving a digitized video stream;
compressing said video stream using a selected first compression algorithm;
recording the compressed video stream;
creating a record indicating that said recorded, compressed video stream was compressed using said selected first compression algorithm; and
storing said record; and
in a second mode of operation, different from said first mode:
retrieving said stored record; and
if the retrieved record indicates that said recorded, compressed video stream was compressed using said first compression algorithm:
reading the recorded, compressed video stream;
processing said recorded, compressed video stream using a selected enhancement algorithm and a selected second compression algorithm;
recording the enhanced, re-compressed video stream;
modifying said record to indicate that said recorded, enhanced, recompressed video stream was processed using said selected enhancement algorithm and said selected second compression algorithm; and
storing said modified record.

14. The method of claim 13 wherein said first mode of operation comprises on-line operation in real time.

15. The method of claim 14 wherein said second mode of operation comprises off-line operation in non-real time.

16. In a video processing method comprising the steps of:
in a first mode of operation:
receiving a digitized video stream;
compressing said video stream using a selected first compression algorithm;
recording the compressed video stream;
creating a record indicating that said recorded, compressed video stream was compressed using said first compression algorithm; and
storing said record;
the improvement comprising: in a second mode of operation, different from said first mode:
retrieving said stored record; and
if the retrieved record indicates that said recorded, compressed video stream was compressed using said first compression algorithm:
reading the recorded, compressed video stream;
processing said recorded, compressed video stream using a selected video processing algorithm;
recording the processed, compressed video stream;
modifying said record to indicate that said recorded, recompressed video stream was processed using said selected video processing algorithm; and
storing said modified record.

17. A video processing apparatus:
operative in a first mode of operation to:
receive a digitized video stream;
compress said video stream using a selected first compression algorithm;
record the compressed video stream;
create a record indicating that said recorded, compressed video stream was compressed using said first compression algorithm; and
store said record; and
operative in a second mode of operation, different from said first mode, to:
retrieve said stored record; and
if the retrieved record indicates that said recorded, compressed video stream was compressed using said first compression algorithm:
read the recorded, compressed video stream;
process said recorded, compressed video stream using a selected video processing algorithm;
record the processed, compressed video stream;
modify said record to indicate that said recorded, re-compressed video stream was processed using said selected video processing algorithm; and
store said modified record.

18. The apparatus of claim 17 wherein:
in processing said recorded, compressed video stream the apparatus recompresses said recorded, compressed video stream using a selected second compression algorithm;
in recording the processed, compressed video stream the apparatus records the re-compressed video stream; and
in modifying said record the apparatus modifies said record to indicate that said recorded, re-compressed video stream was re-compressed using said second compression algorithm.

19. The apparatus of claim 17 wherein:
in processing said recorded, compressed video stream the apparatus enhances said recorded, compressed video stream using a selected enhancement algorithm;
in recording the processed, compressed video stream the apparatus records the enhanced, compressed video stream; and
in modifying said record the apparatus modifies said record to indicate that said recorded, enhanced, compressed video stream was enhanced using said selected enhancement algorithm.

20. The apparatus of claim 17 wherein:
in processing said recorded, compressed video stream the apparatus enhances said video stream using a selected enhancement algorithm, and re-compresses said enhanced video stream using a selected second compression algorithm;
in recording the processed, compressed video stream the apparatus records the enhanced, re-compressed video stream; and
in modifying said record the apparatus modifies said record to indicate that said recorded, enhanced, re-compressed video stream was enhanced using said selected enhancement algorithm and recompressed using said selected second compression algorithm.

21. The apparatus of claim 17 wherein the apparatus is controlled by a digital computer operating in response to a sequence of instructions comprising a computer program.
